(19) United States
(12) Patent Application Publication
(10) Pub. No.: US 2008/0241648 A1
(43) Pub. Date: Oct. 2, 2008

(54) SMALL ELECTRONIC DEVICE

(75) Inventors: Katsushige KOHRI, Osaka-shi (JP); Motoaki MUSHIKA, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/059,691

(22) Filed: Mar. 31, 2008

(30) Foreign Application Priority Data
Mar. 30, 2007 (JP) 2007-093793

(51) Int. Cl. H01M 2/10

(52) U.S. Cl. 429/96

(57) ABSTRACT

The present invention provides a small electronic device including a cabinet body having a battery chamber defined therein, and a battery pack having a battery that is to be received in the battery chamber and is integrated with a battery lid for covering the battery chamber. The battery lid is detachably engaged with the cabinet body. The battery lid of the battery pack includes a rectangular main plate portion in accordance with the opening shape of the battery chamber, two side plate portions projecting from both side ends of the main plate portion to face side plate portions of the cabinet body, and at least two ribs projecting from the inside of the side plate portions to be fitted to the inside of the side plate portions of the cabinet body, with the battery lid being engaged with the cabinet body.

The priority application Number 2007-093793 upon which this patent application is based is hereby incorporated by reference.

### BACKGROUND OF THE INVENTION

1. Field of the Invention

The present invention relates to small electronic devices such as portable telephones.

2. Description of Related Art

Many conventional portable telephones use a battery pack 9 having a battery 90 integrated with a battery lid 91 made of synthetic resin, as shown in FIG. 7.

The battery lid 91 includes a main plate portion 92 and two side plate portions 93, 93 projecting from both ends of the main plate portion 92. The battery 90 and the battery lid 91 are integrated by joining the battery 90 and the main plate portion 92 of the battery lid 91 with ultrasonic welding.

As shown in FIG. 8, a cabinet body 94 of a portable telephone includes two side plate portions 95, 95 at its both ends. The battery pack 9 is accommodated in the cabinet body 94 of the portable telephone.

However, in the battery pack 9 having the battery 90 integrated with the battery lid 91 by ultrasonic welding, the side plate portions 93, 93 of the battery lid 91 can open outward at the time of ultrasonic welding. In this case, there has been a problem in that the side plate portions 93, 93 of the battery lid 91 and the side plate portions 95, 95 of the cabinet body 94 make a positional difference between each other when the battery pack 9 is attached to the cabinet body 94 of the portable telephone.

### SUMMARY OF THE INVENTION

The present invention provides a small electronic device including a cabinet body having a battery chamber R defined therein, and a battery pack having a battery that is to be received in the battery chamber R and is integrated with a battery lid for covering the battery chamber R. The battery lid is detachably engaged with the cabinet body. The battery lid of the battery pack includes a rectangular main plate portion in accordance with the opening shape of the battery chamber R, side plate portions projecting from both side ends of the main plate portion to face side plate portions of the cabinet body, and at least two ribs projecting from the inside of the side plate portions to be fitted to the inside of the side plate portions of the cabinet body, with the battery lid being engaged with the cabinet body.

In a specific configuration, the battery and battery lid of the battery pack are joined to each other by ultrasonic welding.

The above described small electronic device of the present invention prevents a positional difference between the side plate portions of the battery lid and the side plate portions of the cabinet body because the ribs are fitted to the inside of the side plate portions of the cabinet body when the battery pack is attached to the cabinet body to thereby push back inward the side plate portions of the battery lid.

In another specific configuration, the battery lid of the battery pack is made of synthetic resin, and has the at least two ribs integrated therewith.

As described above, the small electronic device of the present invention prevents a positional difference between the side plate portions of the battery lid and the side plate portions of the cabinet body because the position of the side plate portions of the battery lid is corrected when the battery pack is attached to the cabinet body.

### BRIEF DESCRIPTION OF THE DRAWINGS

FIG. 1 is a perspective view of a foldable portable telephone of the present invention;

FIG. 2 is an exploded perspective view of an operation housing of the foldable portable telephone;

FIG. 3 is an exploded perspective view of a battery pack;

FIG. 4 is a perspective view showing the inner surface of a battery lid;

FIG. 5 is an enlarged perspective view of A portion of FIG. 4;

FIG. 6 includes sectional views showing how the position of a side plate portion of the battery lid is corrected by engagement of a rib with a projection;

FIG. 7 is a perspective view showing a battery lid and a battery that are to be ultrasonically welded; and

FIG. 8 is a sectional view showing side plate portions of the battery lid opened outward by ultrasonic welding.

### DETAILED DESCRIPTION OF THE INVENTION

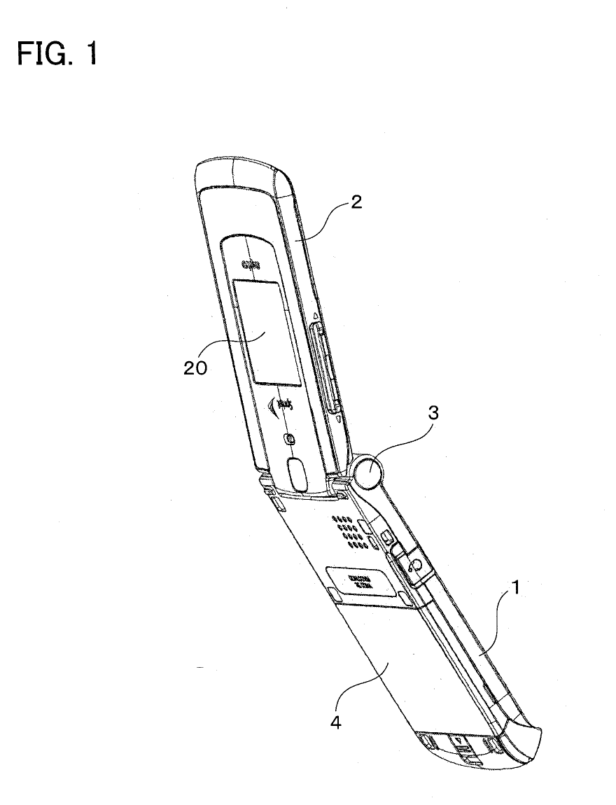

The present invention embodied in a foldable portable telephone is now described with reference to the drawings. As shown in FIG. 1, a foldable portable telephone of the present invention has an operation housing 1 and a display housing 2 that are openably and closably coupled to each other via a hinge mechanism 3.

The operation housing 1 includes a battery pack 4, and has a plurality of operation buttons (not shown) arranged on the facing surface to the display housing 2. The display housing 2 has a main display (not shown) arranged on the facing surface to the operation housing 1, and has a sub display 20 arranged on the back face of the display housing 2.

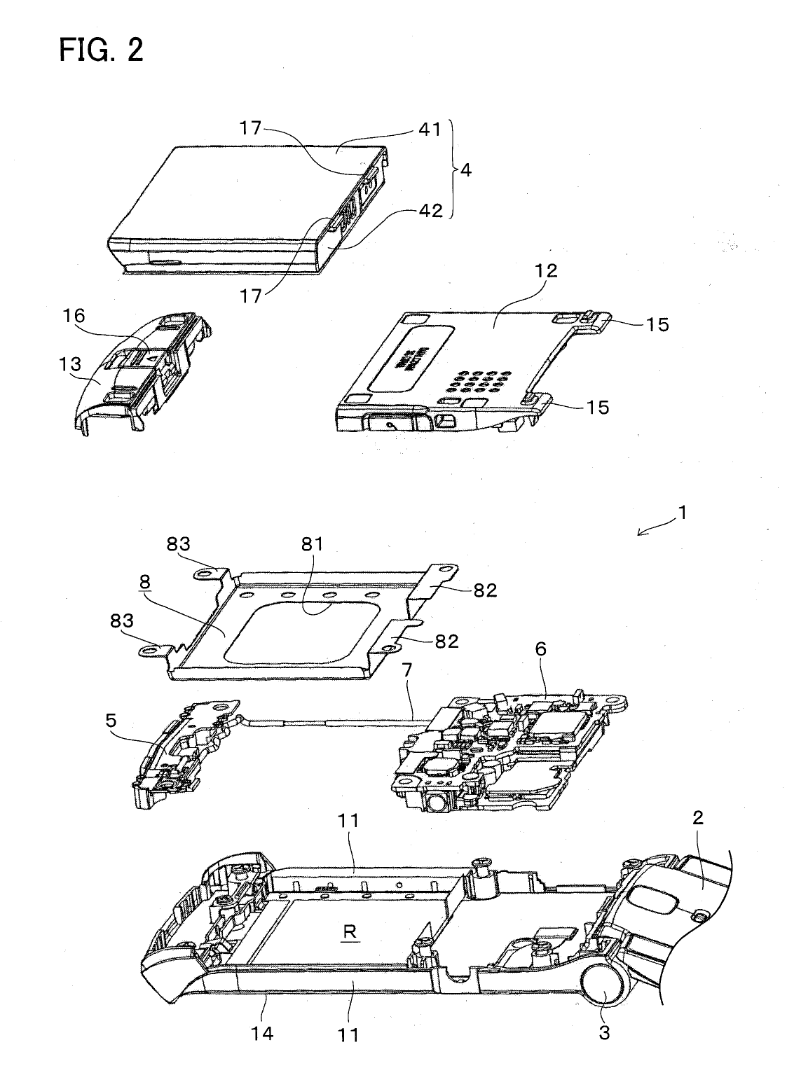

As shown in FIG. 2, the foldable portable telephone of the present invention includes a cabinet body 14 of the operation housing 1 that includes a battery chamber R and two side plate portions 11, 11 projecting from both ends of the battery chamber R. The cabinet body 14 has an antenna substrate 5 and a high frequency substrate 6 that are arranged on opposite sides across the battery chamber R. The antenna substrate 5 and the high frequency substrate 6 are electrically connected to each other by a coaxial cable 7.

A support plate 8 made of stainless steel and centrally having an opening 81 is placed in the battery chamber R. Two first coupling pieces 82, 82 and two second coupling pieces 83, 83 project from both ends of the support plate 8. The two first coupling pieces 82, 82 are coupled to the high frequency substrate 6, and the two second coupling pieces 83, 83 are coupled to the antenna substrate 5. The support plate 8 supports the antenna substrate 5 and the high frequency substrate 6 via the first coupling pieces 82, 82 and the second coupling pieces 83, 83. The coaxial cable 7 is placed between the support plate 8 and the bottom of the battery chamber R.

The antenna substrate 5 is covered with an antenna substrate cover 13. The high frequency substrate 6 is covered with a high frequency substrate cover 12. Two tongues 15, 15 project from an end of the high frequency substrate cover 12. The two tongues 15, 15 cover the hinge mechanism 3.

The battery pack 4 is detachably received via the support plate 8 in the battery chamber R of the cabinet body 14. Two nail pieces 17, 17 project from an end of the battery lid 41, and are inserted into two connection holes (not shown) provided on an end face of the high frequency substrate cover 12 that faces the battery chamber R. The antenna substrate cover 13 has a lock mechanism 16 for locking the battery pack 4. The lock mechanism 16 detachably locks the battery pack 4.

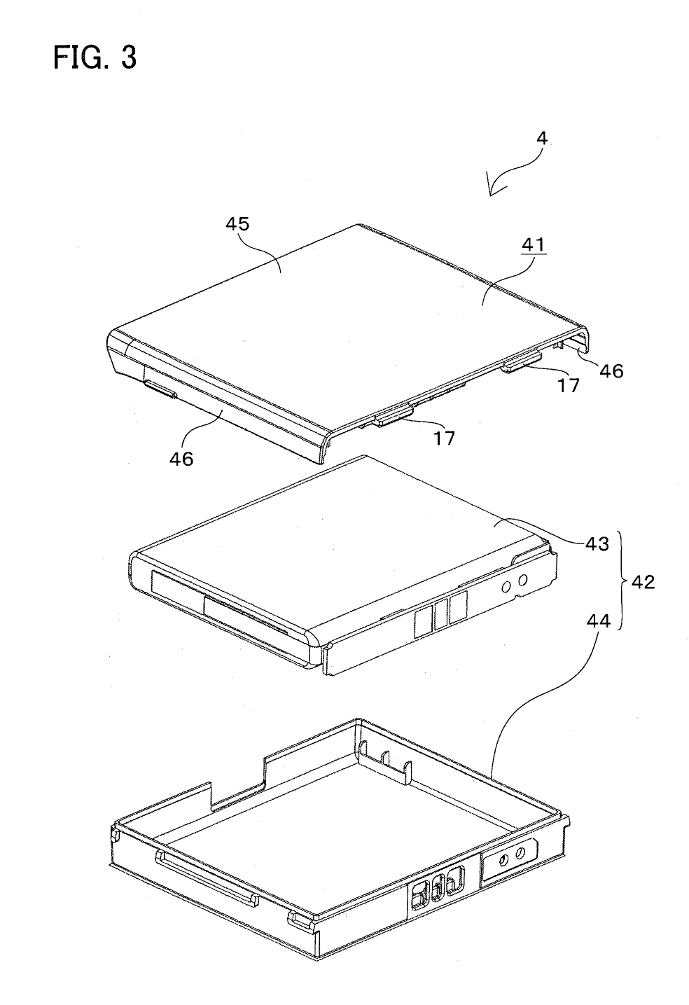

As shown in FIG. 3, the battery pack 4 includes a battery 42 and a battery lid 41 joined to the battery 42 by ultrasonic welding. The battery 42 includes a battery body 43 and a battery case 44 storing the battery body 43. The battery lid 41 has a main plate portion 45 ultrasonically welded to the battery 42 and two side plate portions 46, 46 connected to both ends of the main plate portion 45. The two nail pieces 17, 17 to be inserted into the two connection holes of the high frequency substrate cover 12 project from an end of the main plate portion 45.

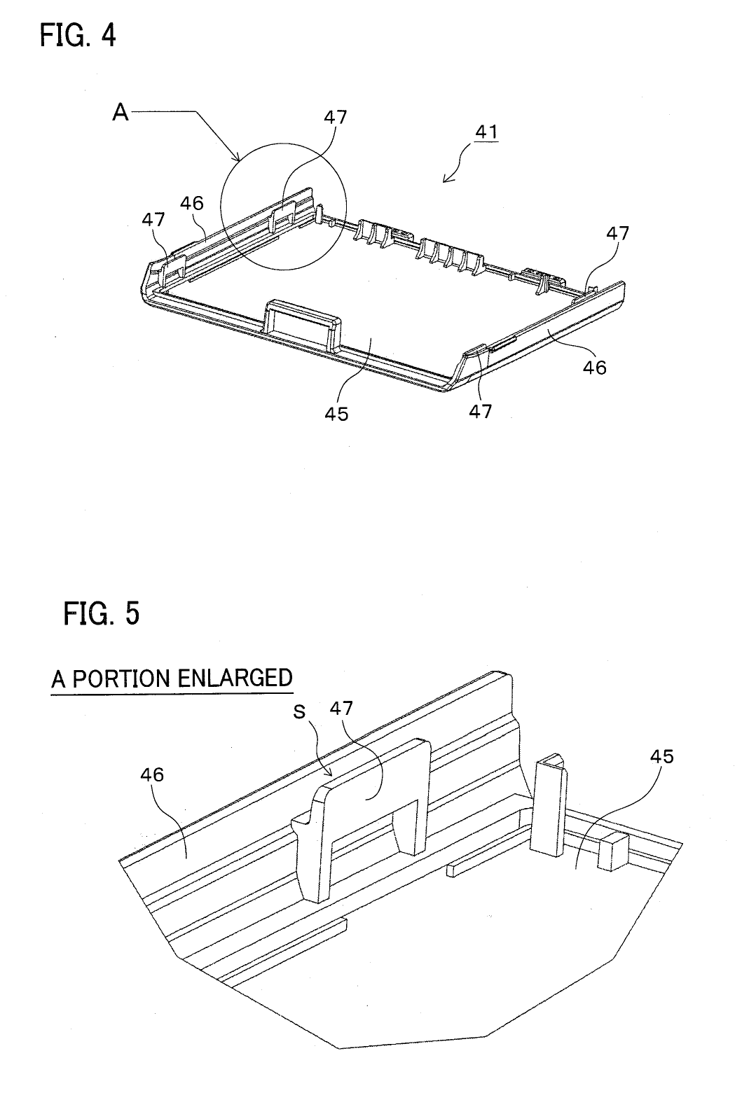

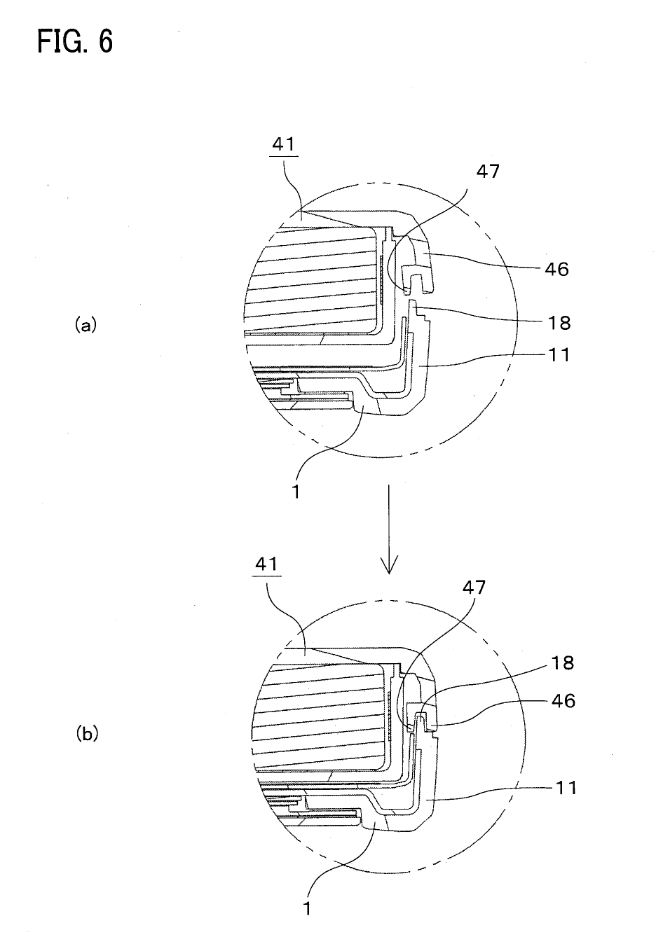

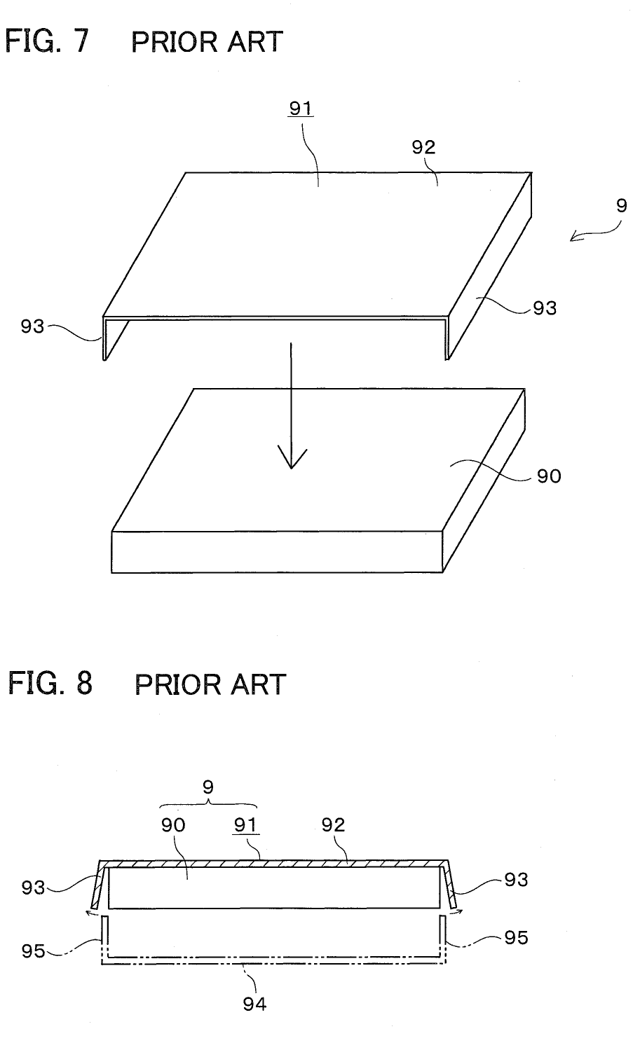

As shown in FIG. 4 and FIG. 5, two ribs 47, 47 project from the inside of each side plate portion 46 on the inner surface of the battery lid 41. As shown in FIG. 6(a), the rib 47 is to be fitted to the inside of the side plate portions 11, 11 of the cabinet body 14 when the battery pack 4 is attached to the battery chamber R. As shown in FIG. 6(b), a projection 18 engaged with the rib 47 projects from an end of each of the side plate portions 11, 11 of the cabinet body 14. Engagement of the rib 47 with the projection 18 causes the projection 18 to press the rib 47, resulting in the side plate portions 46, 46 of the battery lid 41 being pushed inward. This prevents a positional difference between the side plate portions 46, 46 of the battery lid 41 and the side plate portions 11, 11 of the cabinet body 14.

It is desirable that the rib 47 is wedge-shaped. It is also desirable that the rib 47 has an inclined surface S, as shown in FIG. 5, formed on the engaged portion of the rib 47 with the projection 18 to perform a guide function to lead the side plate portion 11 of the cabinet body 14.

The present invention is not limited to the foregoing embodiment in construction but can be modified variously without departing from the spirit of the invention as set forth in the appended claims. Although the present invention embodied in a foldable portable telephone is described in the above described embodiment, the present invention is not limited to this but can be carried out in small electronic devices such as PHSs (Personal Handyphone Systems), laptop personal computers or the like.

What is claimed is:

1. A small electronic device comprising a cabinet body having a battery chamber defined therein, and a battery pack having a battery that is to be received in the battery chamber and is integrated with a battery lid for covering the battery chamber, the battery lid being detachably engaged with the cabinet body, the battery lid of the battery pack including a rectangular main plate portion in accordance with the opening shape of the battery chamber, two side plate portions projecting from both side ends of the main plate portion to face side plate portions of the cabinet body, and at least two ribs projecting from the inside of the side plate portions to be fitted to the inside of the side plate portions of the cabinet body, with the battery lid being engaged with the cabinet body.

2. The small electronic device according to claim 1, wherein the battery and battery lid of the battery pack are joined to each other by ultrasonic welding.

3. The small electronic device according to claim 1, wherein the battery lid of the battery pack is made of synthetic resin, and has the at least two ribs integrated therewith.
